(19) United States
(12) Patent Application Publication
(10) Pub. No.: US 2026/0222322 A1
(43) Pub. Date: Jul. 30, 2026

(54) NETWORK IMPACT ANALYSIS BY A MACHINE LEARNING MODEL BASED ON TARGETED CONTEXT FOR NETWORK TOPOLOGY

(71) Applicant: Cisco Technology, Inc., San Jose, CA (US)

(72) Inventors: Gonzalo Salgueiro, Raleigh, NC (US); Derek William Engi, Pleasant Ridge, MI (US)

(21) Appl. No.: 19/040,979

(22) Filed: Jan. 30, 2025

(51) Int. Cl. H04L 41/50; H04L 41/16

(52) U.S. Cl. CPC H04L 41/5058; H04L 41/16

(57) ABSTRACT

An example embodiment concisely summarizes impact and dependencies between network devices in order to reduce token counts for providing topology information to an AI model for context. The example embodiment provides a minimal amount of relevant information for context when requesting a generative AI model to produce recommendations with respect to troubleshooting and resolving network issues.

### TECHNICAL FIELD

The present disclosure relates to network monitoring and configuration.

### BACKGROUND

Digital twin environments provide a virtual duplicate of a network environment and state, and iterative modeling of what-if scenarios. Further, there are many approaches that attempt to physically or virtually replicate a network environment and perform what-if analysis as a result of network changes. However, time and resources required to duplicate a network either physically or virtually have a significant cost. Moreover, these approaches often cannot perform the exact configuration and feature parity as a production network due to limitations in cost and virtualized functionality.

Large language models (LLMs) and generative Artificial Intelligence (AI) models may be utilized to provide recommendations with respect to implementing changes in network devices. There are also approaches of using LLMs to evaluate topology images and update topology images based on intent, acting as a design co-pilot. However, the processing of a large image or topology via text quickly overwhelms the LLMs. For example, token limitations for input to LLMs (even in the millions) prohibits passing network topology as a parameter to an LLM for evaluating the network topology and producing a response.

### BRIEF DESCRIPTION OF THE DRAWINGS

FIG. 1 is a diagram of an example network environment in which network configuration may be implemented, according to an example embodiment.

FIG. 2 is a flow diagram of a method of configuring a network based on network impact analysis, according to an example embodiment.

FIG. 3 is a flowchart of a method for configuring a network based on network impact analysis, according to an example embodiment.

FIG. 4 is a flowchart of a method for determining dependencies or relationships between network devices, according to an example embodiment.

FIG. 5A illustrates an example dependency matrix indicating dependencies between network devices, according to an example embodiment.

FIG. 5B illustrates an example dependency matrix indicating dependencies between network devices for layers of a communication model or standard, according to an example embodiment.

FIG. 6 illustrates a flowchart of a generalized method for configuring a network based on impact analysis, according to an example embodiment.

FIG. 7 illustrates a hardware block diagram of a computing device configured to perform functions associated with configuring a network as discussed herein, according to an example embodiment.

### DETAILED DESCRIPTION

### Overview

An example embodiment concisely summarizes impact and dependencies between network devices in order to reduce token counts for providing topology information to an AI model for context. The example embodiment provides a minimal amount of relevant information for context when requesting a generative AI model to produce recommendations with respect to troubleshooting and resolving network issues.

### Example Embodiments

An example embodiment physically or virtually replicates an environment and performs what-if analysis as a result of network changes by modelling relationships and dependencies of devices (without the need for actual operating state). The example embodiment uses an operating state of the environment in an extendible manner to better determine relationships that cannot be inferred by a topology image.

An example embodiment provides a lightweight implementation that identifies multiple planes of relationships between network devices and creates an impact index for providing an LLM with additional context of a network operating state when requesting recommendations. The example embodiment addresses token limitations (although in the millions) in LLMs that prohibit or prevent receiving network topology as a parameter to an LLM for evaluating the network topology and producing a response. Further, the example embodiment provides more targeted context to an LLM about technology dependencies and risk when requesting an LLM to evaluate multiple remediation plans. In addition, targeted, technology-specific topology in conjunction with multiple recommendations provide generative models with better context as part of their decision making process.

An example embodiment creates a knowledge graph of dependency across slices of technology and feature sets to summarize dependency and redundancy between network devices. This summarization aids LLMs by providing context for a topology (without the need to supply the entire topology as part of the user or system prompt).

An example embodiment may request a recommendation from an LLM with respect to an impact that a change to a network device (e.g., upgrade, update, replacement, etc.) may have on a total network environment. A conventional approach provides a network topology to an LLM and relies on the LLM to identify relationships that exist between network devices and provides some feasible response as a result. However, networks are complicated, large, and quickly exhaust token limits of most LLMs. The token limits are used to ensure that the LLM responds in an appropriate time. Additional tokens beyond the token limit tend to lead to hallucinations as the LLM grapples with determining relevancy of data included in the prompt. For example, an LLM may return a generic answer as a result of information overload from a given topology and recommendation request.

Accordingly, the example embodiment identifies a weighted dependency between a graph or sub-graph of network devices or elements, and calculates a chain of dependency to which features and services are mapped. The example embodiment summarizes risk of a particular network change for providing context to the LLM, and uses a minimal amount of tokens to define relationships between network devices that are subject to a recommendation or command execution provided by a generative model.

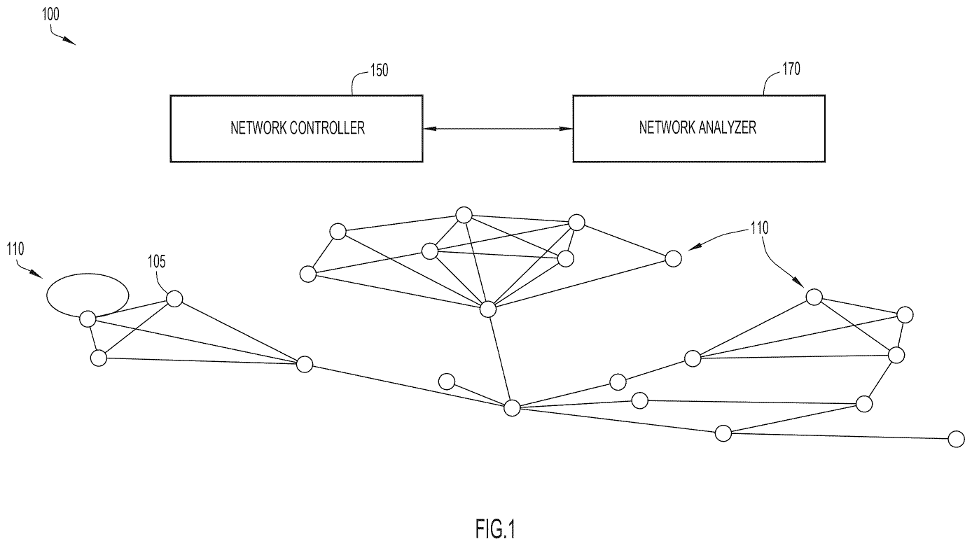

FIG. 1 is a diagram of an example network environment 100 in which network configuration may be implemented, according to an example embodiment. Network environment 100 includes a plurality of interconnected network nodes 105, a network controller 150, and a network analyzer 170. Network nodes 105 perform various communication operations (e.g., routing, receiving and forwarding, data processing, etc.) and may be arranged in any desired configurations. By way of example, network nodes 105 may be arranged (or connected) to form various sub-networks 110 within network environment 100. The sub-networks generally include a portion of the network nodes within network environment 100, and may include any quantity of network nodes 105. Network nodes 105 may be local to each other and/or communicate over network environment 100 that may include one or more wide area networks (WANs), such as the Internet, and one or more local area networks (LANs). The network nodes may communicate with each other over network environment 100 using a variety of known or hereafter developed communication protocols.

Network controller 150 performs various management and/or configuration operations for network environment 100 (e.g., monitoring operations, configuring network nodes or other elements, etc.), while network analyzer 170 predicts an impact on network environment 100 based on various scenarios (e.g., changes to a network node 105, such as upgrade, update, replacement, etc.) according to example embodiments as described below. Network analyzer 170 may be included within, or coupled to, network controller 150. The network nodes and network controller may be implemented by any conventional or other computing or network devices.

By way of example, the techniques of example embodiments are described with respect to routing. However, it will be appreciated that the techniques of example embodiments may be performed with respect to any feature or function that indicates a dependency or relationship between devices (e.g., redundancy, logging, DHCP addresses, or other feature of a networking or other space, etc.). Further, the example embodiments may be applied to any network environment (of any configuration) or other arrangement of devices coupled in any fashion. For example, the devices may be local to each other and/or communicate over a communication network that may include one or more wide area networks (WANs), such as the Internet, and one or more local area networks (LANs). The devices may communicate with each other over the communication network using a variety of known or hereafter developed communication protocols.

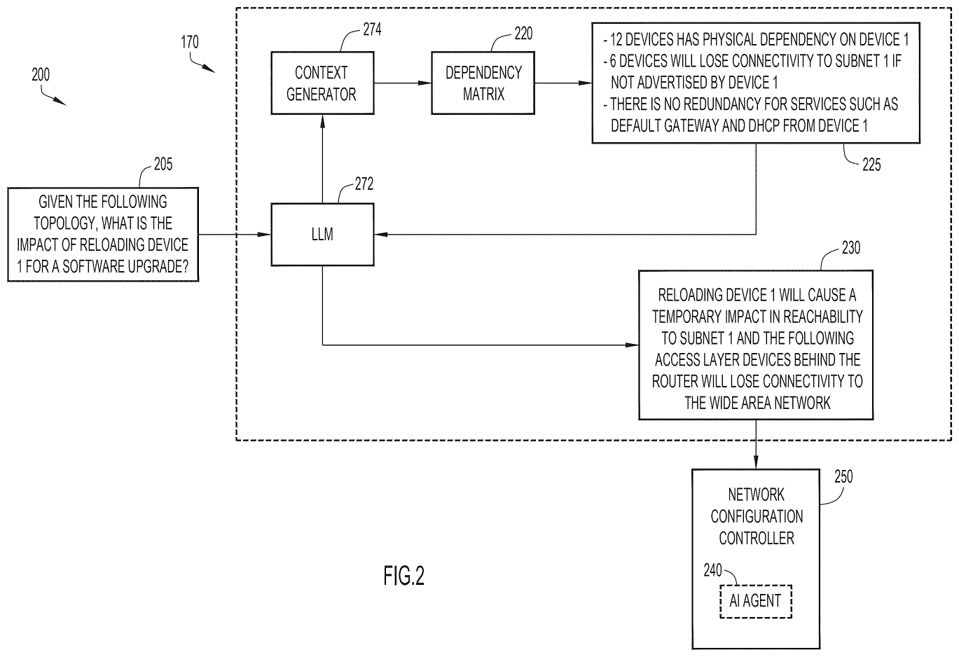

With continued reference to FIG. 1, FIG. 2 illustrates a method 200 of configuring a network based on network impact analysis, according to an example embodiment. By way of example, method 200 is described with respect to routing. However, it will be appreciated that method 200 may be performed with respect to any feature or function that indicates a dependency or relationship between devices.

Initially, network analyzer 170 includes an LLM 272 and a context generator 274. LLM 272 receives a request pertaining to an impact on network environment 100 from an action performed to change a network node 105 (e.g., update, upgrade, replacement, etc. of network node 105). By way of example, LLM 272 may employ any conventional or other large language model (LLM) and natural language processing (NLP) techniques to process the request and provide requested information and/or perform actions. These techniques can parse and understand text, and extract various elements, data types, tasks, and other relevant information. This information can be used to produce results for the request. The LLM may receive a prompt or natural language instruction, and process the prompt to determine the actions to be performed to produce the results. The prompt may include several variations and forms.

However, any quantity of any conventional or other machine learning and/or natural language processing (NLP) models may be used (e.g., mathematical/statistical models, classifiers, feed-forward (fully or partially connected), recurrent (RNN), convolutional (CNN), or other neural networks, deep learning models, long short-term memory (LSTM), attention-based methods/transformers, large language model (LLM), entity extraction, relationship extraction, part-of-speech (POS) taggers, semantic analysis, etc.) that are configured to determine the impact of an action performed to change network node 105.

By way of example, LLM 272 may include, or be implemented by, a neural network. For example, neural networks may include an input layer, one or more intermediate layers (e.g., including any hidden layers), and an output layer. Each layer includes one or more neurons, where the input layer neurons receive input (e.g., text or text features, etc.), and may be associated with weight values. The neurons of the intermediate and output layers are connected to one or more neurons of a preceding layer, and receive as input the output of a connected neuron of the preceding layer. Each connection is associated with a weight value, and each neuron produces an output based on a weighted combination of the inputs to that neuron. The output of a neuron may further be based on a bias value for certain types of neural networks (e.g., recurrent types of neural networks).

The weight (and bias) values may be adjusted based on various training techniques. For example, the machine learning of the neural network may be performed using a training set of various text (e.g., request, etc.) as input and corresponding desired outputs (e.g., results for requests, actions to perform, etc.), where the neural network attempts to produce the provided output and uses an error from the output (e.g., difference between produced and known outputs) to adjust weight (and bias) values (e.g., via backpropagation or other training techniques).

The output layer neurons may indicate a probability for the input data being associated with a corresponding output (e.g., results for requests, actions to perform, etc.). The output with the highest probability may be selected as the result.

LLM 272 is associated with a token limit for the request, and may encounter difficulty providing an appropriate response when the token limit is exceeded, such as when topology of network environment 100 is provided as part of the request. A token may include any quantity or unit of text (e.g., word, n-gram, character, phrase, sentence, etc.). In order to reduce the quantity of tokens for the request (and satisfy the token limit), context generator 274 analyzes network environment 100 to produce context information of the network environment to supplement the request for LLM 272 in order to process the request. Context generator 274 generates or creates dependency matrix 220 including one or more layers based on technology and features.

By way of example, context generator 274 constructs a graph of routing dependencies and advertisements between network nodes 105. The graph maintains sub-networks 110 that are announced and received by each network node 105. The graph is analyzed to determine an impact of a network node being removed from the graph (e.g., no longer participating in the operation indicating the relationship). In the routing example, a network node 105 is iteratively removed from the graph to determine an effect on relationships between network nodes 105. For example, the graph may be evaluated to determine which network nodes lose connectivity to other network nodes or services as a result of a change to each network node. A counter is incremented based on a loss of service associated with the removal of the network node.

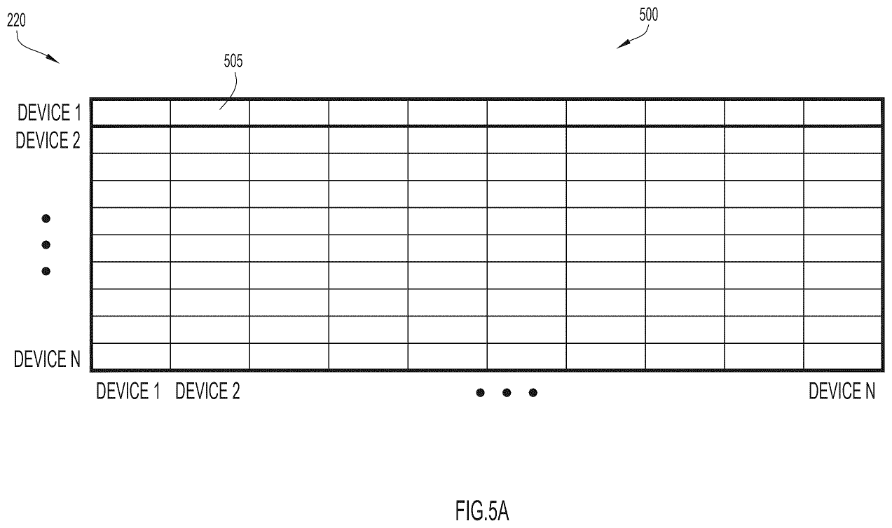

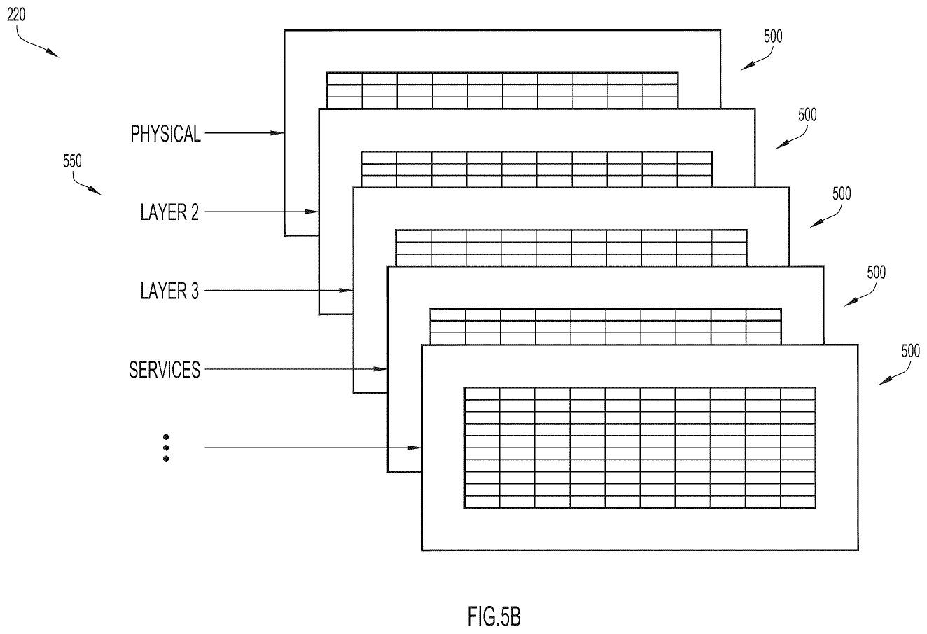

Dependency matrix 220 (FIG. 5A) is generated from the analysis and stores a metric for each pair of network nodes 105 with respect to the effect (e.g., loss of connectivity or service, etc.) of removing a network node. The dependency matrix may include layers each corresponding to a layer of a communication model or standard (e.g., OSI, etc.) (FIG. 5B).

Dependency matrix 220 is used to provide context information 225 as a function of a request from a user for network impact analysis. Context generator 274 extracts or retrieves the context information from dependency matrix 220 based on a query provided from LLM 272. The query is produced based on the information in the request. The query may be of any format, and indicate any criteria for the context information to be retrieved. The context information 225 is provided to LLM 272 to produce a result for the request.

Context generator 274 may include any quantity of any conventional or other machine learning and/or natural language processing (NLP) models (e.g., mathematical/statistical models, classifiers, feed-forward (fully or partially connected), recurrent (RNN), convolutional (CNN), or other neural networks, deep learning models, long short-term memory (LSTM), attention-based methods/transformers, large language model (LLM), entity extraction, relationship extraction, part-of-speech (POS) taggers, semantic analysis, etc.) that are configured to determine the context information based on the query from LLM 272. For example, context generator 274 may include an LLM (including or implemented by a neural network) as described above and trained to analyze dependency matrix 220 and provide the context information based on the query from LLM 272. For example, the machine learning may be performed using a training set of various text (e.g., queries, etc.) as input and corresponding desired outputs (e.g., context information, actions to perform to retrieve the context information, etc.), where the neural network attempts to produce the provided output and uses an error from the output (e.g., difference between produced and known outputs) to adjust weight (and bias) values (e.g., via backpropagation or other training techniques).

A user (e.g., via an end-user device) may provide a request 205 to network analyzer 170 requesting information on a particular network device (or network node 105) and an impact analysis for network environment 100 based on performing an action to change the particular network device (e.g., upgrade, update, replace, etc.). By way of example, the request may include a prompt similar to “Given the following topology, what is the impact of reloading DEVICE 1 for a software upgrade?” (e.g., as viewed in FIG. 2).

LLM 272 processes the request and produces a query for context generator 274 to obtain context information 225 for the request. Since context information is generated by context generator 274 and used by LLM 272, the quantity of tokens in the request to perform the analysis is greatly reduced (e.g., topology of network environment 100 is not needed in the request, etc.), thereby satisfying (or complying with) token limitations for LLM 272 and enabling the LLM to produce an appropriate result. Context generator 274 analyzes dependency matrix 220 and provides targeted context information satisfying the query to LLM 272. The context generator examines levels of dependency and a sphere of influence that the device dictates. By way of example, context information 225 may indicate that 12 devices (or network nodes 105) have physical dependence on a device (or network node 105) (e.g., DEVICE 1), 6 devices (or network nodes 105) lose connectivity to a sub-network 110 (e.g., SUBNET 1) when not advertised by the device (e.g., DEVICE 1), and there is no redundancy for services, such as default gateway and DHCP, from the device (e.g., DEVICE 1) (e.g., as viewed in FIG. 2).

Context information 225 is provided to LLM 272 to supplement the request and enable the LLM to process request 205 and produce a result 230. The result may indicate that reloading the device (or network node 105) (e.g., DEVICE 1) causes a temporary impact in reachability to sub-network 110 (e.g., SUBNET 1) and the following access layer devices behind the router will lose connectivity to the Wide Area Network (e.g., as viewed in FIG. 2).

Thus, in this example, a temporary reload of the device (or network node 105) (e.g., DEVICE 1) has a negative impact to directly connected physical devices and affects routing advertisements to adjacent peers. This level of information can be used by the user, an AI agent 240, and/or a network configuration controller 250 (of network controller 150) to further assess risk and/or perform actions. Network configuration controller 250 (of network controller 150) manages configuration of network environment 100, and may be coupled to, or include, AI agent 240 to interpret result 230.

AI agent 240 may include any quantity of any conventional or other machine learning and/or natural language processing (NLP) models (e.g., mathematical/statistical models, classifiers, feed-forward (fully or partially connected), recurrent (RNN), convolutional (CNN), or other neural networks, deep learning models, long short-term memory (LSTM), attention-based methods/transformers, large language model (LLM), entity extraction, relationship extraction, part-of-speech (POS) taggers, semantic analysis, etc.) that are configured to interpret result 230 from LLM 272. For example, AI agent 240 may include an LLM (e.g., including or implemented by a neural network) as described above and trained to analyze result 230 for positive or negative effects or impacts. By way of example, the machine learning may be performed using a training set of various text (e.g., results, etc.) as input and corresponding desired outputs (e.g., positive or negative effect, actions to perform, etc.), where the neural network attempts to produce the provided output and uses an error from the output (e.g., difference between produced and known outputs) to adjust weight (and bias) values (e.g., via backpropagation or other training techniques).

For example, result 230 may be provided to network configuration controller 250. In this case, since the upgrade of the device (or network node 105) (e.g., DEVICE 1) has a negative impact, network configuration controller 250 avoids (or is prevented from) upgrading the device (e.g., AI agent 240 may prevent network configuration controller 250 from performing the upgrade based on determining the upgrade has a negative impact, etc.). Alternatively, when the upgrade does not have a negative impact, network configuration controller 250 may automatically perform the upgrade (e.g., AI agent 240 may direct network configuration controller 250 to perform the upgrade based on determining the upgrade has no negative effect (or a positive effect, etc.)).

With continued reference to FIGS. 1 and 2, FIG. 3 illustrates a method 300 for configuring a network based on network impact analysis, according to an example embodiment. By way of example, method 300 is described with respect to routing. However, it will be appreciated that method 300 may be performed with respect to any feature or function that indicates a dependency or relationship between devices.

Initially, context generator 274 of network analyzer 170 determines dependencies or relationships within network environment 100 at operation 305. This may be performed as a pre-processing operation prior to LLM 272 of network analyzer 170 processing a request for network impact analysis. Context generator 274 may receive topology information for network environment 100 (e.g., information pertaining to network connectivity, etc.) provided to network analyzer 170. The network analyzer may receive a request for network impact analysis and the topology information, and provide the topology information to context generator 274 and the impact analysis request to LLM 272. The resulting dependencies or relationships determined by context generator 274 are provided in the form of dependency matrix 220. For example, context generator 274 may construct a graph of routing dependencies and advertisements between network nodes 105. The graph maintains sub-networks 110 that are announced and received by each network node 105. The graph is analyzed to determine an impact of a network node being removed from the graph (e.g., no longer participating in the operation indicating the relationship). For example, the graph may be evaluated to determine which network nodes lose connectivity to other network nodes or services as a result of a change to each network node. A counter is incremented based on a loss of service associated with the removal of the network node. Dependency matrix 220 stores a metric for each pair of network nodes 105 with respect to the effect (e.g., loss of connectivity or service, etc.) of removing a network node. The dependency matrix may include layers each corresponding to a layer of a communication model or standard (e.g., OSI, etc.).

The request for network impact analysis is received at LLM 272 at operation 310. The request may request information on a particular network device (or network node 105) of network environment 100 and a network impact analysis for network environment 100 based on performing an action to change the particular network device (e.g., hardware, software or other upgrade or update, replacement, etc.).

LLM 272 processes the request and produces a query for context generator 274 to retrieve or obtain context information for the request at operation 315. Since context information is generated by context generator 274 and used by LLM 272, the quantity of tokens in the request to perform the analysis is greatly reduced (e.g., topology of network environment 100 is not needed in the request, etc.), thereby satisfying (or complying with) token limitations for LLM 272 and enabling the LLM to produce an appropriate result.

Context generator 274 analyzes the dependencies and/or relationships to produce targeted context information based on the query from LLM 272 at operation 320. By way of example, the context information may indicate network devices (or network nodes 105) that have physical dependence on the network device of the request, the quantity of network devices (or network nodes 105) that lose connectivity to sub-networks 110 when not advertised by the network device of the request, and/or redundancy for services from the network device of the request.

The context information is provided to LLM 272 to process the request and produce a result at operation 325. The result may indicate that the action performed to change the network device has a negative or positive impact or effect on network environment 100. When the action does not have a negative impact or effect on network environment 100 as determined at operation 330 (e.g., by AI agent 240, etc.), the action is performed at operation 335. For example, network configuration controller 250 may automatically perform the action to alter the network configuration (e.g., AI agent 240 may direct network configuration controller 250 to perform the upgrade or update based on determining the upgrade or update has no negative effect (or a positive effect, etc.)). Alternatively, if the action has a negative impact or effect on network environment 100, the action is not performed.

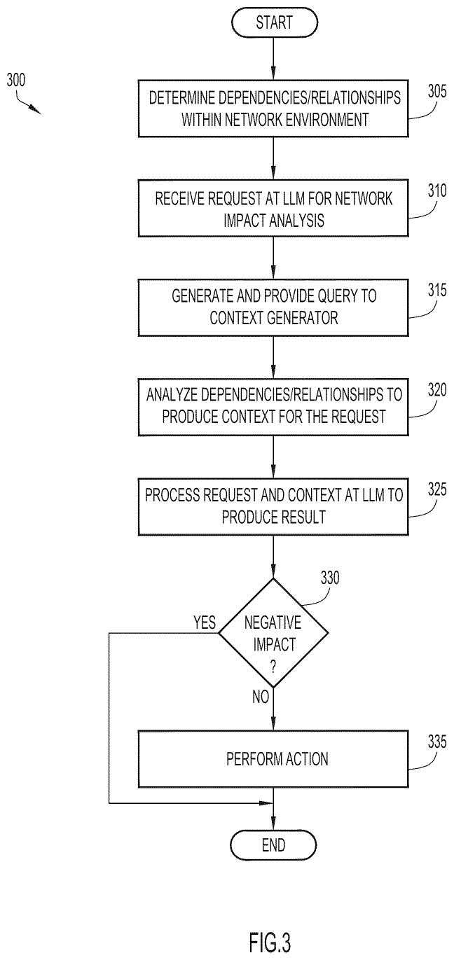

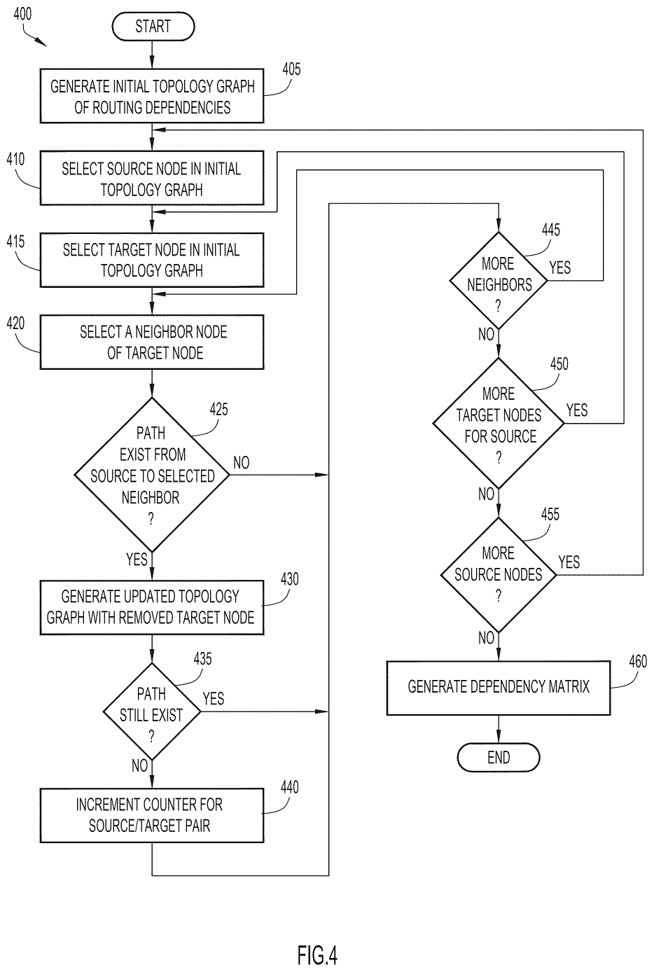

With continued reference to FIGS. 1-3, FIG. 4 illustrates a method 400 for determining dependencies or relationships between network devices, according to an example embodiment. This may correspond to operation 305 of FIG. 3. By way of example, method 400 is described with respect to routing. However, it will be appreciated that method 400 may be performed with respect to any feature or function that indicates a dependency or relationship between devices.

Initially, context generator 274 constructs or generates an initial topology graph of routing dependencies and advertisements between network nodes 105 of network environment 100 at operation 405. This graph maintains sub-networks 110 that are announced and received by each network node 105. The initial topology graph is adjusted and analyzed to determine an impact of a network node being removed from the initial topology graph (e.g., no longer participating in the operation indicating the relationship). For example, the initial topology graph may be adjusted and evaluated to determine which network nodes lose connectivity to other network nodes or services as a result of a change to each network node. A counter is incremented based on a negative impact or effect (e.g., loss of service associated with the removal of the network node, etc.).

A network node 105 is selected from the initial topology graph as a source node at operation 410, and another network node 105 is selected from the initial topology graph as a target node at operation 415. The source and target nodes are used for determining paths or connectivity within the initial topology graph. For example, the existence of a path between the source node and each neighboring node of the target node is determined after removal of the target node from the initial topology graph. The absence of a path between the source node and a neighboring node of the target node when the target node is removed indicates a negative impact (e.g., loss of connectivity, etc.) with respect to performing an action to change the target node (e.g., upgrade, update, replace, etc.).

A neighbor node of the target node is selected from the initial topology graph at operation 420. The existence of a path in the initial topology graph between the source node and selected neighbor node is determined. When the path exists as determined at operation 425, an updated topology graph is generated from the initial topology graph with the target node removed at operation 430. When the path between the source node and selected neighbor node no longer exists in the updated topology graph (with removal of the target node) as determined at operation 435, a counter is incremented for the pair of source node and target node at operation 440. The counter basically maintains a quantity of negative impacts or effects (e.g., loss of connectivity, etc.) for the source and target node pair.

When the path on the initial topology graph does not exist between the source node and selected neighbor node as determined at operation 425, the path no longer exists in the updated topology graph (with removal of the target node) as determined at operation 435, or the counter is incremented at operation 440, the above process repats from operation 420 in substantially the same manner described above until the remaining neighbor nodes of the target node have been processed as determined at operation 445.

Once the source and selected target node pair have been processed as determined at operation 445, the above process repeats from operation 415 to select and process a new target node in substantially the same manner described above until the remaining target nodes of the initial topology graph have been processed as determined at operation 450. In other words, a pair of the source node and a next target node is analyzed to determine a quantity of negative impacts or effects (e.g., loss of connectivity, etc.) for this pair.

Once the source node and target nodes have been processed as determined at operation 450, the above process repeats from operation 410 to select and process a new source node in substantially the same manner described above until the remaining source nodes of the initial topology graph have been processed as determined at operation 455. In other words, pairs of a next source node with each target node is analyzed to determine a quantity of negative impacts or effects (e.g., loss of connectivity, etc.) for these pairs.

Once the source nodes and corresponding target nodes have been processed as determined at operation 455, a dependency matrix is generated at operation 460. The dependency matrix stores a metric for each pair of source and target nodes with respect to the effect (e.g., loss of connectivity or service, etc.) of removing the target node. In this case, the dependency matrix indicates the quantities of negative impacts of effects for each pair of nodes in network environment 100 (e.g., quantity of paths or routes lost, etc.). The dependency matrix may include layers each corresponding to a layer of a communication model or standard (e.g., OSI, etc.). The quantity of impacts may be determined for each pair of nodes for each layer in substantially the same manner described above based on one or more metrics specific to that layer.

With continued reference to FIGS. 1-4, FIG. 5A illustrates an example dependency matrix 220 indicating dependencies or relationships between network devices, according to an example embodiment. By way of example, devices that have large negative values are indicative of having strong relationships and levels of dependency to each other (e.g., the values may represent percentage decreases (or negative percentages) with respect to a metric, etc.). For example, network nodes 105 with a large quantity of negative effects indicated by the counter described above (e.g., corresponding to a large negative percentage, etc.) represent a strong dependency or relationship between the network nodes. Since the counter may represent a quantity of lost paths or routes, a greater quantity of paths or routes being lost when a network node of a pair is removed indicates a strong dependence or relationship between the network nodes of the pair.

Dependency matrix 220 may be represented in the form of a table 500 including rows for each source network node 105 (e.g., DEVICE 1, DEVICE 2 to DEVICE N as viewed in FIG. 5A) and columns for each target network node 105 (e.g., DEVICE 1, DEVICE 2 to DEVICE N as viewed in FIG. 5A). Cells 505 each reside in table 500 at an intersection of a row and column, and indicate a corresponding metric for the source and target network nodes whose row and column intersects. The metric indicates the impact or effect on the source node when an action is performed to change the target node (which may cause the target node to cease operation or be removed). By way of example, cell 505 may indicate a percentage of routing table changes (e.g., lost or removed paths or routes, etc.) for the source node when the target node is removed (e.g., due to loss of route advertisements, loss of a path or route to a network node based on the removed target node, etc.). This may be based on the quantity of negative impacts or effects for the source and target node pair described above (e.g., the decrease in quantity of paths or routes in the routing table for the source node (due to loss) (e.g., maintained by the counter and represented as a negative number to show a decrease, etc.) divided by the total number of paths or routes in the routing table of the source node (-[quantity of lost routes]/total routes in routing table).

With continued reference to FIGS. 1-4 and 5A, FIG. 5B illustrates an example dependency matrix 220 indicating dependencies or relationships between network devices for layers of a communication model or standard (e.g., OSI, etc.), according to an example embodiment. Dependency matrix 220 may illustrate a multi-layer approach of creating a dependency index based on technologies/features from one network device to another. The layers can be independent (e.g., context about services or features disabled on a network device are not considered and deemed irrelevant) to provide targeted dependency information. The multi-layer approach allows inheritance of dependency from one layer to the next (e.g., a physical connection removal between network devices at a first (or physical) layer may have impact at other layers).

Dependency matrix 220 may include a series of layers 550. The layers may each correspond to a layer of a communication model or standard. By way of example, layers 550 may correspond to one or more layers of the Open Systems Interconnection (OSI) model including Physical, Data Link, Network, Transport, Session, Presentation, and Application layers (e.g., corresponding to Physical, Layer 2, Layer 3, Services, etc. as shown in FIG. 5B). Dependency matrix 220 may include a table 500 for each layer 550. Table 500 includes rows for each source network node 105 and columns for each target network node 105 with cells 505 each residing in table 500 at an intersection of a row and column. The cells indicate a corresponding layer specific metric for the source and target network nodes whose row and column intersect as described above. The metric indicates the impact or effect on the source node within the corresponding layer when an action is performed to change the target node (which may cause the target node to cease operation or be removed). Further, the multi-layers allow inheritance of dependency and/or relationships from one layer to anther layer (e.g., a physical connection removal between network devices at a physical layer may have impact at other layers).

Further, dependency matrix 220 may be represented as a multidimensional table, where a cell of the multidimensional table may have plural dimensions each with a metric value for a corresponding layer of the communication model.

Context generator 274 may analyze one or more layers of dependency matrix 220 based on a query from LLM 272 to provide targeted (or layer specific) context information to LLM 272 to process a request in substantially the same manner described above.

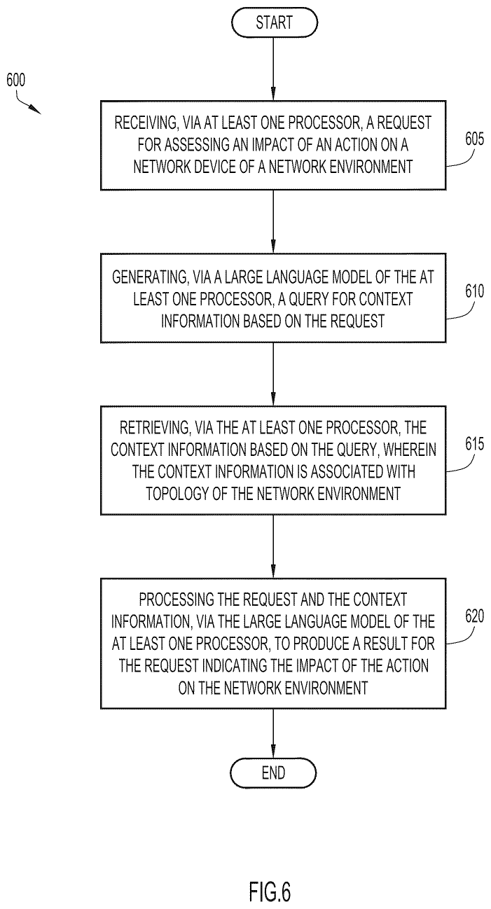

FIG. 6 is a flowchart of an example method 600 for configuring a network based on impact analysis, according to an example embodiment. At operation 605, a request is received, via at least one processor, for assessing an impact of an action on a network device of a network environment. At operation 610, a large language model of the at least one processor generates a query for context information based on the request. At operation 615, the context information is retrieved, via the at least one processor, based on the query. The context information is associated with topology of the network environment. At operation 620, the request and the context information are processed, via the large language model of the at least one processor, to produce a result for the request indicating the impact of the action on the network environment.

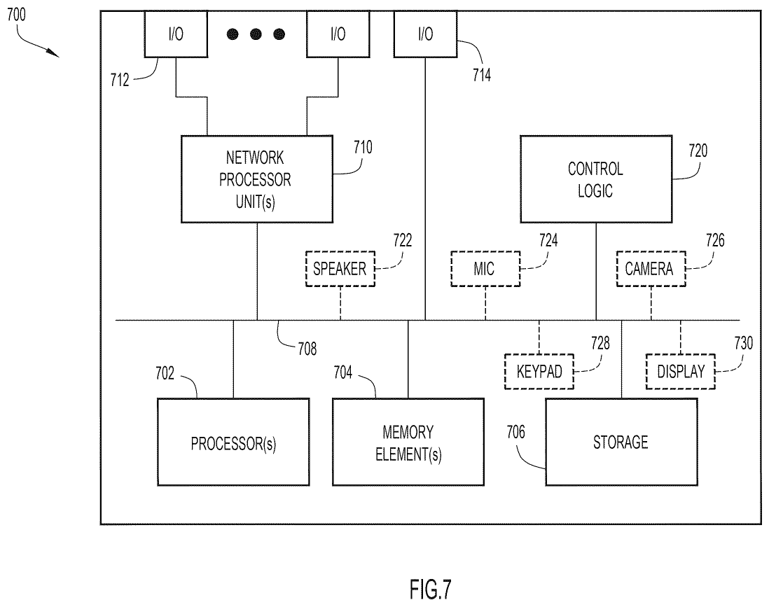

Referring to FIG. 7, FIG. 7 illustrates a hardware block diagram of a computing device 700 that may perform functions associated with operations discussed herein in connection with the techniques depicted in FIGS. 1-4, 5A, 5B , and 6. In various embodiments, a computing device or apparatus or system, such as computing device 700 or any combination of computing devices 700, may be configured as any device entity/entities (e.g., network nodes, computer devices, end-user devices, servers, client devices, communication devices, network devices, processors, switching devices, network interfaces, agents, routers, network controller, network analyzer, etc.) as discussed for the techniques depicted in connection with FIGS. 1-4, 5A, 5B, and 6 in order to perform operations of the various techniques discussed herein.

In at least one embodiment, computing device 700 may be any apparatus that may include one or more processor(s) 702, one or more memory element(s) 704, storage 706, a bus 708, one or more network processor unit(s) 710 interconnected with one or more network input/output (I/O) interface(s) 712, one or more I/O interface(s) 714, and control logic 720. In various embodiments, instructions associated with logic for computing device 700 can overlap in any manner and are not limited to the specific allocation of instructions and/or operations described herein.

In at least one embodiment, processor(s) 702 is/are at least one hardware processor configured to execute various tasks, operations and/or functions for computing device 700 as described herein according to software and/or instructions configured for computing device 700. Processor(s) 702 (e.g., a hardware processor) can execute any type of instructions associated with data to achieve the operations detailed herein. In one example, processor(s) 702 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 704 and/or storage 706 is/are configured to store data, information, software, and/or instructions associated with computing device 700, and/or logic configured for memory element(s) 704 and/or storage 706. For example, any logic described herein (e.g., control logic 720) can, in various embodiments, be stored for computing device 700 using any combination of memory element(s) 704 and/or storage 706. Note that in some embodiments, storage 706 can be consolidated with memory elements 704 (or vice versa), or can overlap/exist in any other suitable manner.

In at least one embodiment, bus 708 can be configured as an interface that enables one or more elements of computing device 700 to communicate in order to exchange information and/or data. Bus 708 can be implemented with any architecture designed for passing control, data and/or information between processors, memory elements/storage, peripheral devices, and/or any other hardware and/or software components that may be configured for computing device 700. In at least one embodiment, bus 708 may be implemented as a fast kernel-hosted interconnect, potentially using shared memory between processes (e.g., logic), which can enable efficient communication paths between the processes.

In various embodiments, network processor unit(s) 710 may enable communication between computing device 700 and other systems, entities, etc., via network I/O interface(s) 712 to facilitate operations discussed for various embodiments described herein. In various embodiments, network processor unit(s) 710 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 700 and other systems, entities, etc. to facilitate operations for various embodiments described herein. In various embodiments, network I/O interface(s) 712 can be configured as one or more Ethernet port(s), Fibre Channel ports, any other I/O port(s), and/or antenna(s)/antenna array(s) now known or hereafter developed. Thus, the network processor unit(s) 710 and/or network I/O interfaces 712 may include suitable interfaces for receiving, transmitting, and/or otherwise communicating data and/or information in a network environment.

I/O interface(s) 714 allow for input and output of data and/or information with other entities that may be connected to computing device 700. For example, I/O interface(s) 714 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

With respect to certain entities (e.g., client device, end-user device, network device, network nodes, processors, network interfaces, switching devices, agents, routers, etc.), computing device 700 may further include, or be coupled to, a speaker 722 to convey sound, microphone or other sound sensing device 724, camera or image capture device 726, a keypad or keyboard 728 to enter information (e.g., alphanumeric information, etc.), and/or a touch screen or other display 730. These items may be coupled to bus 708 or I/O interface(s) 714 to transfer data with other elements of computing device 700.

In various embodiments, control logic 720 can include instructions that, when executed, cause processor(s) 702 to perform operations, which can include, but not be limited to, providing overall control operations of computing device 700; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

Present embodiments may provide various technical and other advantages. In an embodiment, the request provided to the LLM has significantly reduced tokens, thereby enabling the LLM to process less information and reduce processing or response time while maintaining accuracy. This also reduces consumption of processing and memory/storage resources to improve computing performance. In an embodiment, the context information is targeted to the request to avoid processing additional extraneous information, thereby improving response time. The analysis of the network topology and generation of the context information is offloaded from the LLM to improve performance, while the request is reduced to satisfy LLM token limits and maintain accuracy.

In an embodiment, the machine learning model (and/or LLM prompts) may be continuously updated (or trained) based on feedback related to results. For example, a result may be indicated as a negative impact or effect, where a user may still enable an action to be performed on a network device. The resulting action may be used to update or train the machine learning model (or LLM prompt) to increase the confidence that the result reflects a positive impact (e.g., update or train the machine learning model to increase the probability of the result indicating a positive impact, alter prompts to produce a result more likely to indicate a positive impact, etc.). A similar approach may be used for a result indicating a positive impact or effect, where a user may still prevent an action to be performed on a network device. Thus, the machine learning model (or LLM prompt) may continuously evolve (or be trained) to learn to produce appropriate positive and negative impacts and/or actions to perform as actions are enabled or prevented by the user. Further, the dependency matrix may be updated periodically or in real time as a network (or network elements) change (e.g., upgrade or update software of network nodes or elements, adding or removing network nodes form a network, etc.).

The programs described herein (e.g., control logic 720) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

Data relating to operations described herein may be stored within any conventional or other data structures (e.g., files, arrays, lists, stacks, queues, records, etc.) and may be stored in any desired storage unit (e.g., database, data or other stores or repositories, queue, etc.). The data transmitted between device entities may include any desired format and arrangement, and may include any quantity of any types of fields of any size to store the data. The definition and data model for any datasets may indicate the overall structure in any desired fashion (e.g., computer-related languages, graphical representation, listing, etc.).

The present embodiments may employ any number of any type of user interface (e.g., graphical user interface (GUI), command-line, prompt, etc.) for obtaining or providing information, where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The environment of the present embodiments may include any number of computer or other processing systems (e.g., client or end-user systems, server systems, network devices, storage devices, etc.) and databases or other repositories arranged in any desired fashion, where the present embodiments may be applied to any desired type of computing environment (e.g., cloud computing, client-server, network computing, mainframe, stand-alone systems, datacenters, etc.). The computer or other processing systems employed by the present embodiments may be implemented by any number of any personal or other type of computer or processing system (e.g., desktop, laptop, Personal Digital Assistant (PDA), mobile devices, etc.), and may include any commercially available operating system and any combination of commercially available and custom software. These systems may include any types of monitors and input devices (e.g., keyboard, mouse, voice recognition, etc.) to enter and/or view information.

It is to be understood that the software of the present embodiments may be implemented in any desired computer language and could be developed by one of ordinary skill in the computer arts based on the functional descriptions contained in the specification and flowcharts and diagrams illustrated in the drawings. Further, any references herein of software performing various functions generally refer to computer systems or processors performing those functions under software control. The computer systems of the present embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., Local Area Network (LAN), Wide Area Network (WAN), Intranet, Internet, hardwire, modem connection, wireless, etc.). For example, the functions of the present embodiments may be distributed in any manner among the various network devices, storage devices, and other processing devices or systems, and/or any other intermediary processing devices. The software and/or algorithms described above and illustrated in the flowcharts and diagrams may be modified in any manner that accomplishes the functions described herein. In addition, the functions in the flowcharts, diagrams, or description may be performed in any order that accomplishes a desired operation.

The networks of present embodiments may be implemented by any number of any type of communications network (e.g., LAN, WAN, Internet, Intranet, Virtual Private Network (VPN), etc.). The computer or other processing systems of the present embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., LAN, hardwire, wireless link, Intranet, etc.).

Each of the elements described herein may couple to and/or interact with one another through interfaces and/or through any other suitable connection (wired or wireless) that provides a viable pathway for communications. Interconnections, interfaces, and variations thereof discussed herein may be utilized to provide connections among elements in a system and/or may be utilized to provide communications, interactions, operations, etc. among elements that may be directly or indirectly connected in the system. Any combination of interfaces can be provided for elements described herein in order to facilitate operations as discussed for various embodiments described herein.

In various embodiments, any device entity or apparatus as described herein may store data/information in any suitable volatile and/or non-volatile memory item (e.g., magnetic hard disk drive, solid state hard drive, semiconductor storage device, Random Access Memory (RAM), Read Only Memory (ROM), Erasable Programmable ROM (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more device entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, Digital Signal Processing (DSP) instructions, software [potentially inclusive of object code and source code], etc.) for execution by one or more processor(s), and/or other similar machine, etc. Generally, memory element(s) 704 and/or storage 706 can store data, software, code, instructions (e.g., processor instructions), logic, parameters, combinations thereof, and/or the like used for operations described herein. This includes memory elements 704 and/or storage 706 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, Compact Disc ROM (CD-ROM), Digital Versatile Disc (DVD), memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any Local Area Network (LAN), Virtual LAN (VLAN), Wide Area Network (WAN) (e.g., the Internet), Software Defined WAN (SD-WAN), Wireless Local Area (WLA) access network, Wireless Wide Area (WWA) access network, Metropolitan Area Network (MAN), Intranet, Extranet, Virtual Private Network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi 6®), IEEE 802.16 (e.g., Worldwide Interoperability for Microwave Access (WiMAX)), Radio-Frequency Identification (RFID), Near Field Communication (NFC), Bluetooth™, mm. wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may be directly or indirectly connected utilizing any algorithms, communication protocols, interfaces, etc. (proprietary and/or non-proprietary) that allow for the exchange of data and/or information.

In various example implementations, any device entity or apparatus for various embodiments described herein can encompass network elements (which can include virtualized network elements, functions, etc.) such as, for example, network appliances, forwarders, routers, servers, switches, gateways, bridges, load-balancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four device entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ or ‘frame’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv 4 ) and/or IP version 6 (IPv 6 ) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more device entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combinations of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

In one form, a method is provided. The method comprises: receiving, via at least one processor, a request for assessing an impact of an action on a network device of a network environment; generating, via a large language model of the at least one processor, a query for context information based on the request; retrieving, via the at least one processor, the context information based on the query, wherein the context information is associated with topology of the network environment; and processing the request and the context information, via the large language model of the at least one processor, to produce a result for the request indicating the impact of the action on the network environment.

In one example, the method further comprises analyzing, via the at least one processor, the network environment to determine relationships between network devices, wherein the context information is determined based on the relationships.

In one example, analyzing the network environment comprises constructing a topology graph of the network environment indicating dependencies between the network devices, and iteratively removing a network device from the topology graph and determining the impact on remaining network devices based on a network metric to indicate the relationships.

In one example, the method further comprises generating a dependency matrix indicating the network metric for pairs of network devices in the network environment.

In one example, the dependency matrix includes a plurality of layers each corresponding to a layer of a communication model and indicating the network metric for the network devices at that layer.

In one example, the action includes an update to the network device.

In one example, the large language model includes a token limit for prompts that prevents receiving the topology of the network environment, and the request satisfies the token limit and the context information supplements the request to enable the large language model to produce the result.

In another form, an apparatus is provided. The apparatus comprises a computer device; memory; and at least one processor configured to perform operations comprising: receiving a request for assessing an impact of an action on a network device of a network environment; generating, via a large language model, a query for context information based on the request; retrieving the context information based on the query, wherein the context information is associated with topology of the network environment; and processing the request and the context information, via the large language model, to produce a result for the request indicating the impact of the action on the network environment.

In another form, one or more non-transitory computer readable storage media are provided. The one or more non-transitory computer readable storage media are encoded with processing instructions that, when executed by one or more processors, cause the one or more processors to perform operations comprising: receiving a request for assessing an impact of an action on a network device of a network environment; generating, via a large language model, a query for context information based on the request; retrieving the context information based on the query, wherein the context information is associated with topology of the network environment; and processing the request and the context information, via the large language model, to produce a result for the request indicating the impact of the action on the network environment.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A method comprising:
receiving, via at least one processor, a request for assessing an impact of an action on a network device of a network environment;
generating, via a large language model of the at least one processor, a query for context information based on the request;
retrieving, via the at least one processor, the context information based on the query, wherein the context information is associated with topology of the network environment; and
processing the request and the context information, via the large language model of the at least one processor, to produce a result for the request indicating the impact of the action on the network environment.

2. The method of claim 1, further comprising:
analyzing, via the at least one processor, the network environment to determine relationships between network devices, wherein the context information is determined based on the relationships.

3. The method of claim 2, wherein analyzing the network environment comprises:
constructing a topology graph of the network environment indicating dependencies between the network devices; and
iteratively removing a network device from the topology graph and determining the impact on remaining network devices based on a network metric to indicate the relationships.

4. The method of claim 3, further comprising:
generating a dependency matrix indicating the network metric for pairs of network devices in the network environment.

5. The method of claim 4, wherein the dependency matrix includes a plurality of layers each corresponding to a layer of a communication model and indicating the network metric for the network devices at that layer.

6. The method of claim 1, wherein the action includes an update to the network device.

7. The method of claim 1, wherein the large language model includes a token limit for prompts that prevents receiving the topology of the network environment, and wherein the request satisfies the token limit and the context information supplements the request to enable the large language model to produce the result.

8. An apparatus comprising:
a computer device;
memory; and
at least one processor configured to perform operations comprising:
receiving a request for assessing an impact of an action on a network device of a network environment;
generating, via a large language model, a query for context information based on the request;
retrieving the context information based on the query, wherein the context information is associated with topology of the network environment; and
processing the request and the context information, via the large language model, to produce a result for the request indicating the impact of the action on the network environment.

9. The apparatus of claim 8, wherein the at least one processor is further configured to perform operations comprising:
analyzing the network environment to determine relationships between network devices, wherein the context information is determined based on the relationships.

10. The apparatus of claim 9, wherein analyzing the network environment comprises:
constructing a topology graph of the network environment indicating dependencies between the network devices; and
iteratively removing a network device from the topology graph and determining the impact on remaining network devices based on a network metric to indicate the relationships.

11. The apparatus of claim 10, wherein the at least one processor is further configured to perform operations comprising:
generating a dependency matrix indicating the network metric for pairs of network devices in the network environment.

12. The apparatus of claim 11, wherein the dependency matrix includes a plurality of layers each corresponding to a layer of a communication model and indicating the network metric for the network devices at that layer.

13. The apparatus of claim 8, wherein the large language model includes a token limit for prompts that prevents receiving the topology of the network environment, and wherein the request satisfies the token limit and the context information supplements the request to enable the large language model to produce the result.

14. One or more non-transitory computer readable storage media encoded with processing instructions that, when executed by one or more processors, cause the one or more processors to perform operations comprising:
receiving a request for assessing an impact of an action on a network device of a network environment;
generating, via a large language model, a query for context information based on the request;
retrieving the context information based on the query, wherein the context information is associated with topology of the network environment; and
processing the request and the context information, via the large language model, to produce a result for the request indicating the impact of the action on the network environment.

15. The one or more non-transitory computer readable storage media of claim 14, wherein the processing instructions further cause the one or more processors to perform operations comprising:
analyzing the network environment to determine relationships between network devices, wherein the context information is determined based on the relationships.

16. The one or more non-transitory computer readable storage media of claim 15, wherein analyzing the network environment comprises:
constructing a topology graph of the network environment indicating dependencies between the network devices; and
iteratively removing a network device from the topology graph and determining the impact on remaining network devices based on a network metric to indicate the relationships.

17. The one or more non-transitory computer readable storage media of claim 16, wherein the processing instructions further cause the one or more processors to perform operations comprising:
generating a dependency matrix indicating the network metric for pairs of network devices in the network environment.

18. The one or more non-transitory computer readable storage media of claim 17, wherein the dependency matrix includes a plurality of layers each corresponding to a layer of a communication model and indicating the network metric for the network devices at that layer.

19. The one or more non-transitory computer readable storage media of claim 14, wherein the action includes an update to the network device.

20. The one or more non-transitory computer readable storage media of claim 14, wherein the large language model includes a token limit for prompts that prevents receiving the topology of the network environment, and wherein the request satisfies the token limit and the context information supplements the request to enable the large language model to produce the result.
